(19) United States
(12) Patent Application Publication
(10) Pub. No.: US 2003/0095184 A1
(43) Pub. Date: May 22, 2003

(54) Electronic reception method

(75) Inventor: Chih-Ming Lin, Hsinchu (TW)

Correspondence Address: Ladas & Parry, 26 West 61st Street, New York, NY, 10023, US

(73) Assignee: ACCTON TECHNOLOGY COPRORATION

(21) Appl. No.: 10/072,502

(22) Filed: Feb. 6, 2002

(30) Foreign Application Priority Data
Nov. 22, 2001 (TW) 90128959

(51) Int. Cl. H04N 7/18

(52) U.S. Cl. 348/156; 348/143

(57) ABSTRACT

The present invention discloses an electronic reception method utilizing a computer to generate a virtual receptionist to guide any visitor to easily find the contact person in accordance with the guidance of the virtual receptionist. If the contact person is away from his/her seat, the reception method may connect to the predetermined telephone to reduce the waiting time of the visitor. In addition, the present invention can e-mail the visitor's image to the contact person by local area network or Internet for visitor identification by the contact person. If not meeting the visitor, the contact person is able to know the situation of the visit and respond adequately.

### BACKGROUND OF THE INVENTION

(A) Field of the Invention

The present invention generally relates to a reception method. More particularly, it relates to an electronic reception method.

(B) Description of Related Art

At present, the security system installed at the entrance to any company office is typically an electronic sensor setting a receptionist at the lobby, so only people with electronic access cards or badges are able to pass the gate. Usually, a visitor has to dial the extension number of the contact person at the reception desk first to ask the person to bring him in from outside (of the office). However, the visitor must check the extension number list if it is forgotten. This kind of visitor reception system, in fact, may encounter the following problems:

(1) If the contact person is away from his or her seat or unavailable while the visitor is trying to contact him by phone, the visitor must wait at the lobby until he can ask other people passing by the entrance to deliver a message to the contact person.

(2) If the contact person is a new employee and his or her extension number is not updated yet, visitors would not be able to obtain the extension number of the contact person.

(3) If the contact person's extension line is always busy, the visitor cannot reach the contact person until the contact person hangs off his phone.

In addition, as the wages of employees are always ramping up, to save the cost of a receptionist is becoming one factor of cost reduction. Besides, no service is provided when the receptionist is away from his or her seat, and if the receptionist is a new employee, his/her unfamiliarity with the company's reception operation may affect the quality of service. Hence, an electronic reception (called e-Reception hereinafter) system is becoming an alternative for companies.

### SUMMARY OF THE INVENTIION

The main object of the present invention is to provide an e-Reception method to avoid the visitor waiting due to the contact person being unreachable and to send an e-mail including the visitor's image to the contact person for an adequate response.

An embodiment of the e-Reception method of the present invention comprises the following steps: obtain the image of the reception using a video camera; enable a reception program if the video camera detects any visitor; the visitor selects the contact person following the guidance of the reception program; and deliver the visitor's image to the contact person by e-mail and connect the visitor to the extension of the contact person.

Furthermore, if the visitor fails to reach the contact person, the reception program will connect former to the cellular phone of the contact person.

The method mentioned above may add a step of enabling a multimedia program before detecting a visitor by the video camera.

### BRIEF DESCRIPTION OF THE DRAWINGS

FIG. 1 illustrates the implementation apparatus of the e-Reception method in accordance with the present invention;

FIG. 2 is the flow chart of the e-Reception method in accordance with the present invention; and

FIG. 3 is an example of a display showing on the screen of the reception monitor in accordance with the present invention.

### DETAILED DESCRIPTION OF THE INVENTION

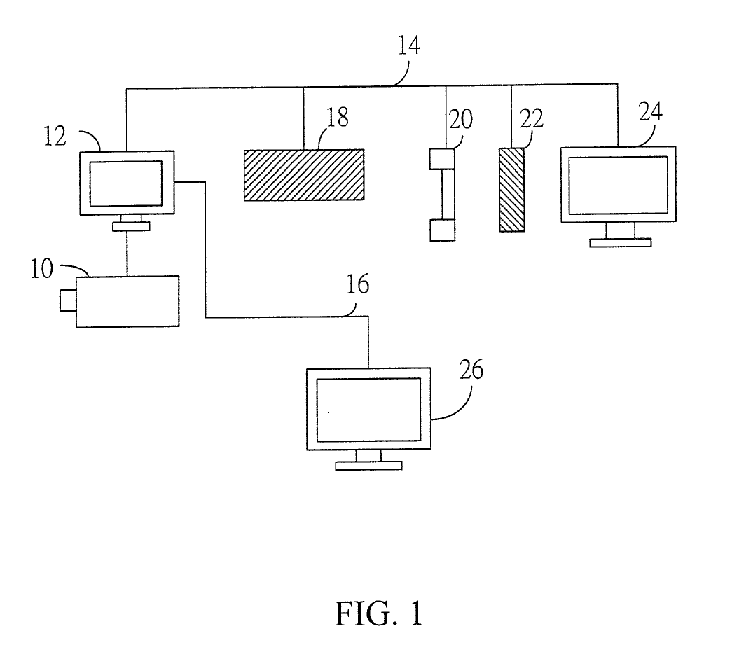

FIG. 1 illustrates the implementation apparatus of the e-Reception method of the present invention. The apparatus utilizes a video camera 10 installed at reception area to obtain images, the video camera 10 is associated with a reception computer 12. The reception computer 12, is associated with a LAN (Local Area Network) 14 and an Internet 16, performs the analysis and differentiation of the image and is able to, base on the predetermined setting, connect to the contact person's extension or send an e-mail to the contact person via the LAN 14 or to remote computer 26 of the contact person via Internet 16. The connections of the reception computer 12, the e-mail system 18, the contact person's extension 20, the dialing system of cellular phone 22 and the contact person's computer 24 are via the LAN 14.

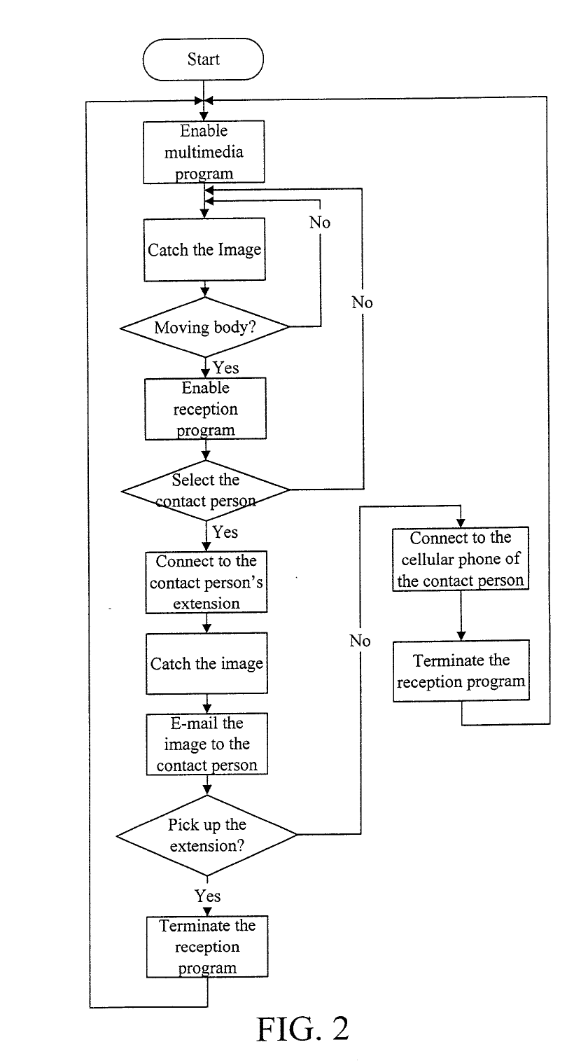

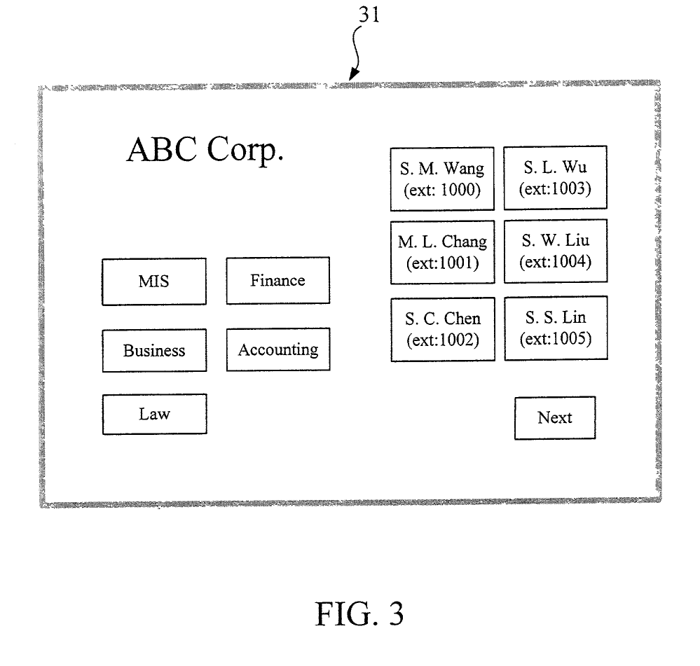

FIG. 2 is the flow chart of the e-Reception method in accordance with the present invention. First of all, enabling a multimedia program may produce light music and show energetic motion pictures while the visitor is waiting. The video camera continuously obtains the image of reception area and utilizes the reception computer 12 to perform the analysis and differentiation of the image to differentiate any moving body around the reception area. If any moving body is detected, the reception program is enabled. Otherwise, it keeps obtaining the image of the reception area. Referring to FIG. 3, after enabling the reception program, the touch controlled computer monitor pops a display 31 which lists the departments, plays a pre-recorded welcome message simultaneously and shows a virtual receptionist to guide the visitor to select the contact person's department, and then the name and extension number of employees of the department. The visitor can continue selecting the contact person shown on the screen, and the reception program will connect the visitor to the contact person's extension automatically. If the contact person does not pick up the phone, it will automatically connect the visitor to the cellular phone of the contact person. Also, the reception program may obtain the visitor's image and e-mail the image to the contact person, then terminate the reception program and reactivate the multimedia program. If the monitor is not touched for a predetermined time, the system will terminate the reception program and reactivate the multimedia program to screen out the missing visitor or the moving bodies.

The e-Reception method mentioned above is able to resolve the issue that visitor is unaware of the contact person's extension number and the contact person can obtain the visitor's image by e-mail. Hence, the contact person would be aware of the visit and respond adequately afterward if the visitor does not reach the contact person's extension or leaves no message. Furthermore, because the contact person is able to obtain the visitor's image in advance, he or she can screen out unwanted visitors, e.g. salesman, and reduce security concerns.

The above-described embodiment of the present invention are intended to be illustratively only. Numerous alternative embodiments may be devised by those skilled in the art without departing from the scope of the following claims.

What is claimed is:

1. An electronic reception method, comprising the steps of:
obtaining an image of a reception area by a video camera;
enabling a reception program if said video camera detects a visitor;
selecting a contact person by said visitor with a guidance of said reception program; and
transferring said obtained image to said contact person by e-mail and connecting to said contact person's extension.

2. The electronic reception method of claim 1, further comprising a step of enabling a multimedia program before said video camera detects a visitor.

3. The electronic reception method of claim 1, further comprising a step of connecting said contact person's cellular phone if the connection to said contact person's extension is failed.

4. The electronic reception method of claim 1, further comprising a step of e-mailing said image to the remote computer used by said contact person.

5. The electronic reception method of claim 1, wherein connecting said contact person's extension and e-mailing said image are via a local area network.
